(19) United States
(12) Patent Application Publication
(10) Pub. No.: US 2015/0066750 A1
(43) Pub. Date: Mar. 5, 2015

(54) Payments Perfection and Processing System

(71) Applicant: Bank of America Corporation, Charlotte, NC (US)

(72) Inventors: Geoffrey R. Williams, Midlothian, TX (US); Kenneth R. Cox, Mooresville, NC (US); Erin K. Cassell, Charlotte, NC (US); Joshua A. Beaudry, Jersey City, NJ (US); Kerry M. Cantley, Fort Mill, SC (US); Tami M. Shepard, Battle Ground, WA (US); Haywood P. Enloe, Houston, TX (US); Leslie M. LaRock, Davidson, NC (US); Timmy L. Gauvin, Peachtree City, GA (US); Clarence E. Lee, II, Mansfield, TX (US)

(21) Appl. No.: 14/536,770

(22) Filed: Nov. 10, 2014

Related U.S. Application Data
(63) Continuation of application No. 13/629,734, filed on Sep. 28, 2012.

(51) Int. Cl. G06Q 20/38

(52) U.S. Cl. CPC G06Q 20/38
USPC 705/39

(57) ABSTRACT

Data associated with a payment may be perfected before additional processing. An image file is received during a first time period, and a processor determines, during the first time period, data associated with the image file. The processor automatically determines, during the first time period, one or more exceptions associated with the data by evaluating if the data meets one or more exception rules. The processor performs, during the first time period, one or more data perfection procedures triggered by the one or more exceptions to obtain perfected data. The processor sends, during the first time period, the perfected data to a posting application.

### RELATED APPLICATIONS

This application is a continuation of application Ser. No. 13/629,734 filed Sep. 28, 2012, entitled “Payments Perfection and Processing System.”

### TECHNICAL FIELD OF THE INVENTION

The present invention relates generally to the field of transaction processing and more particularly to a payments perfection and processing system.

### BACKGROUND OF THE INVENTION

Various types of payments, such as checks or cash letters, may be received at a number of different types of endpoints, such as ATMs, banks, or mobile applications. In order for these payments to post properly, payment “perfection”—a process in which discrepancies, issues, and/or exceptions related to a transaction are identified and resolved—may be beneficial. Conventional payment perfection methods may utilize different payment perfection systems for different types of payments or for payments received at different types of endpoints, which may hinder efficiency, extensibility, economies of scale, and other aspects of the system. Conventional payment perfection method may also utilize different systems to handle different types of payment perfection, which may increase the amount of time before a payments posts to an account in addition to hindering efficiency, extensibility, economies of scale, and other aspects of the system.

### SUMMARY OF THE DISCLOSURE

In accordance with the present invention, disadvantages and problems associated with perfecting and processing payments may be reduced or eliminated.

According to one embodiment, data associated with a payment may be perfected before additional processing. An image file is received during a first time period, and a processor determines, during the first time period, data associated with the image file. The processor automatically determines, during the first time period, one or more exceptions associated with the data by evaluating if the data meets one or more exception rules. The processor performs, during the first time period, one or more data perfection procedures triggered by the one or more exceptions to obtain perfected data. The processor sends, during the first time period, the perfected data to a posting application.

Certain embodiments of the invention may provide one or more technical advantages. A technical advantage of one embodiment may provide a more streamlined and efficient payment perfection system, which may reduce costs associated with payment perfection and facilitate the posting of payments within a shorter time period. Another technical advantage of an embodiment allows a payment perfection system to handle different sources and types of payments with a single processing channel. Thus, subsequent updates to and development of the payment perfection system may apply to all types of payments and endpoints utilizing the system, providing larger economies of scale and improving the extensibility of the system.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that facilitates payment perfection;

FIG. 2 illustrates a particular embodiment of perfection logic that facilitates the payment perfection;

FIG. 3 illustrates an example GUI that facilitates input by a user regarding payment perfection;

FIG. 4 illustrates another example GUI that facilitates input by a user regarding payment perfection; and

FIG. 5 is a diagram that illustrates a payment perfection sequence.

### DETAILED DESCRIPTION OF THE DRAWINGS

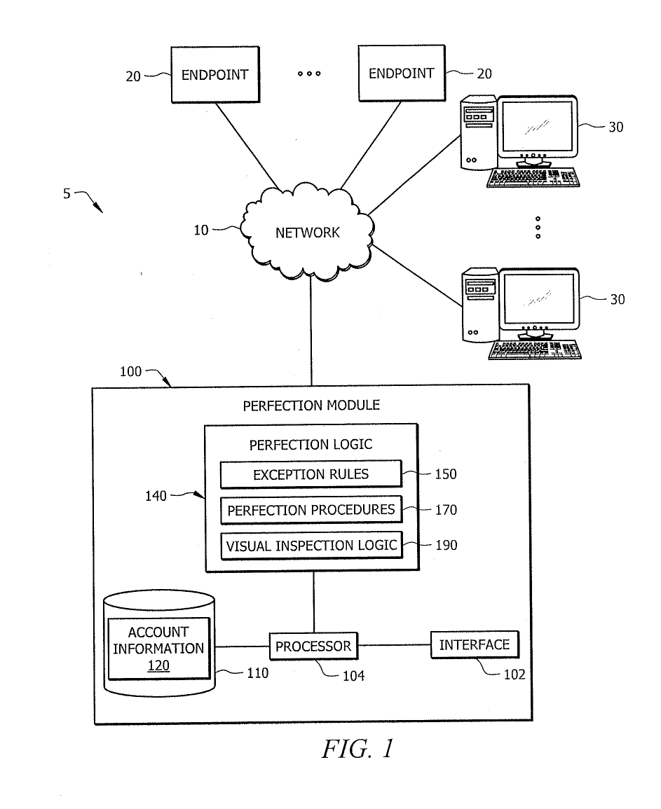

FIG. 1 illustrates an example system 5 that perfects data for subsequent processing. System 5 includes perfection module 100, which communicates with one or more endpoints 20 and one or more workstations 30 over network 10. Perfection module 100 includes processor 104, which is communicatively coupled to network interface 102, memory 110, and perfection logic 150. Perfection logic 140 includes exception rules 150, perfection procedures 170, and visual inspection logic 190, which facilitate perfection processing.

Users may make various payments at endpoints 20 that involve different numbers and types of documents, such as checks or cash letters. Image files associated with these documents and, optionally, other data associated with the payments, may be sent to perfection module 100 through network 10. Perfection module 100 determines data associated with the payment, automatically determines exceptions that may be associated with the data, and performs processing to facilitate perfection of the data before sending the perfected data to a posting application. For example, outdated account numbers or formats may be identified and either corrected or flagged for further exception handling, high-dollar payments may be identified and reviewed before posting, and duplicate payments may be detected and removed. Perfection module 100 may thus provide a more streamlined and efficient payment perfection system, which may reduce costs associated with payment perfection and facilitate the posting of payments within a shorter time period. Furthermore, since perfection module 100 may handle different sources and types of payments, subsequent development of perfection module 100 may apply to all types of payments and endpoints utilizing perfection module 100.

As used herein, the term “perfected” is not meant to require that a payment or data associated with a payment be absolutely error-free, authorized, or otherwise proper. Furthermore, as used herein, the term “posting” refers to the act of applying funds to or drawing funds from an account based on the receipt of credit or debit items.

According to the illustrated embodiment, system 5 includes endpoints 20 that communicate with perfection module 100 through network 10. Endpoints 20 may be ATM machines, banks, smart phones, or any suitable device capable of sending an image file. Endpoints 20 may communicate image files to perfection module 100 that depict checks, cash letters, or other documents related to or evidencing one or more transactions. For example, a user may deposit a check at an ATM machine, which then produces an image file containing a visual representation of the check and sends that image file and, optionally, data associated with the image file to perfection module 100. In another example, a user seeking to deposit a check may use a smart phone to generate an image file depicting the check and send the image file to perfection module 100. Furthermore, different types of endpoints 20 may communicate with perfection module 100 concurrently, which may improve the speed and efficiency of data perfection by providing a uniform, more streamlined data perfection flow and eliminating redundant components. Allowing multiple types of endpoints 20 to utilize the same data perfection flow may also improve extensibility, since upgrades to and debugging of perfection module 100 apply throughout system 5, and because newly developed types of endpoints can simply be designed to communicate with the existing interface of perfection module 100 rather than requiring the development of a separate perfection module. The redundancy-eliminating nature of perfection module 100 may also provide better economies of scale.

Workstations 30 enable one or more users to provide input to one or more steps of the perfection processing performed by perfection module 100. Workstations 30 may include one or more laptops, personal computers, monitors, display devices, handheld devices, smartphones, servers, user input devices, or other suitable components for enabling user input. During payment perfection processing, a workstation 30 may enable a user to manually review exceptions, images, and/or data associated with a payment. In some embodiments, after perfection module 100 identifies an exception associated with payment data, a workstation 30 may retrieve an image file associated with the payment, present an image based on the image file on a display screen, and receive input from a user indicating acceptance of the data, modification of the data, or flagging of the data for further exception handling. For example, in some embodiments, perfection module 100 may identify a payment that exceeds a high dollar exception trigger value and then communicate with a workstation 30 to enable visual inspection of the image and/or data associated with the payment. A user interacting with workstation 30 may then choose to accept the high dollar payment, modify the data, or flag the payment for further exception handling. Workstations 30 may allow system 5 to more quickly and efficiently obtain targeted visual or other manual review of certain payments. Workstations 30 may also provide a more uniform, efficient, and extensible method of targeted manual review for different sources and types of payments as well as different types of exceptions associated with these payments.

Network 10 represents any suitable network operable to facilitate communication between the components of system 5. Network 10 may include any interconnecting system capable of transmitting audio, video, signals, data, messages, or any combination of the preceding. Network 10 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components.

Perfection module 100 represents any suitable components that facilitate the perfection of payments in system 5. Perfection module 100 may include a network server, remote server, mainframe, host computer, workstation, web server, personal computer, file server, or any other suitable device operable to communicate with endpoints 20 and process data. In some embodiments, perfection module 100 may execute any suitable operating system such as IBM's zSeries/Operating System (z/OS), MS-DOS, PC-DOS, MAC-OS, WINDOWS, UNIX, OpenVMS, Linux or any other appropriate operating systems, including future operating systems. The functions of perfection module 100 may be performed by any suitable combination of one or more servers or other components at one or more locations. In the embodiment where the modules are servers, the servers may be public or private servers, and each server may be a virtual or physical server. The server may include one or more servers at the same or at remote locations. Also, perfection module 100 may include any suitable component that functions as a server.

In the illustrated embodiment, perfection module 100 includes network interface 102, processor 104, memory 110, and perfection logic 140.

Network interface 102 represents any suitable device operable to receive information from network 10, transmit information through network 10, perform suitable processing of the information, communicate to other devices, or any combination of the preceding. For example, network interface 102 receives from endpoints 20 image files and/or data associated with payments. As another example, network interface 102 communicates information regarding exceptions associated with payments to workstations 30 to facilitate perfection procedures. Network interface 102 represents any port or connection, real or virtual, including any suitable hardware and/or software, including protocol conversion and data processing capabilities, to communicate through a LAN, WAN, or other communication system that allows perfection module 100 to exchange information with network 10, endpoints 20, workstations 30, other perfection modules 100, or other components of system 10.

Processor 104 communicatively couples to network interface 102 and memory 110, and controls the operation and administration of perfection module 100 by processing information received from network interface 102 and memory 110. Processor 104 includes any hardware and/or software that operates to control and process information. For example, processor 104 executes perfection logic 140 to control the operation of perfection module 100. Processor 104 may be a programmable logic device, a microcontroller, a microprocessor, any suitable processing device, or any suitable combination of the preceding.

Memory 110 stores, either permanently or temporarily, data, operational software, or other information for processor 104, other components of perfection module 100, or other components of system 5. Memory 110 includes any one or a combination of volatile or nonvolatile local or remote devices suitable for storing information. For example, memory 110 may include random access memory (RAM), read only memory (ROM), flash memory, magnetic storage devices, optical storage devices, network storage devices, cloud storage devices, or any other suitable information storage device or a combination of these devices. While illustrated as including particular modules, memory 110 may include any suitable information for use in the operation of perfection module 100. In the illustrated embodiment, memory 110 includes account information 120.

Account information 120 may include names, dates, account numbers, addresses, amounts, institutions, groups, or any other information associated with an account. Although the illustrated embodiment depicts account information 120 stored in memory 110, in other embodiments account information 120 may be stored in one or more other components of system 5 in place of or in addition to memory 110. For example, in one embodiment, account information 120 may be stored in a remote database and retrieved by perfection module 100 through network 10 as needed during perfection processing. In another embodiment, perfection module 100 may retrieve account information 120 from a remote database and store it in a local cache, such as memory 110, to allow for faster access.

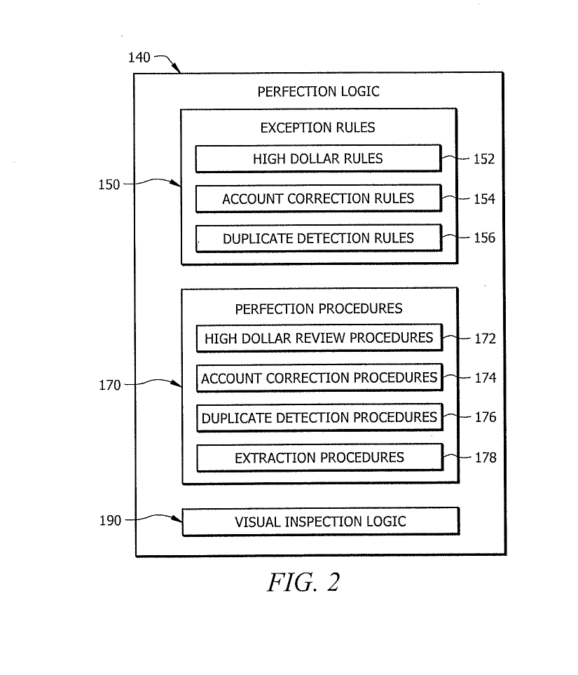

In the illustrated embodiment, perfection logic 140 includes exception rules 150, perfection procedures 170, and visual inspection logic 190. Perfection logic 140 represents any suitable set of instructions, logic, or code embodied in a computer-readable storage medium and operable to facilitate the operation of perfection module 100. Perfection logic 140 may be stored in memory 110 or another memory associated with perfection module 100. Perfection logic 140, or portions thereof, may also be embodied in hardware associated with perfection module 100 or other components of system 5. Furthermore, the components of perfection logic 140 may be stored in the same or different memories of the same or different perfection modules 100. Components of perfection logic 140 may also be stored in different components of system 5. For example, in some embodiments, exception rules 150 and perfection procedures 170 may be stored in memory 110 while visual inspection logic 190 is stored in workstations 30. Various portions of the components of perfection logic 140 may be similarly stored in the same or different components of system 5. Perfection logic 140 is discussed in greater detail below in relation to FIG. 2.

Exception rules 150 represent any suitable set of instructions, logic, or code embodied in a computer-readable storage medium and operable to facilitate the determination of exceptions associated with a payment. Perfection module 100 may evaluate payment data against one or more exceptions rules 150 to determine whether one or more perfection procedures 170 should be executed.

Perfection procedures 170 represent any suitable set of instructions, logic, or code embodied in a computer-readable storage medium and operable to facilitate the handling of exceptions associated with payments. Perfection procedures 170 may operate to automatically evaluate and resolve an exception or facilitate manual review of an exception by a user. For example, perfection procedures 170 may evaluate and modify information associated with a payment. In another example, perfection procedures may facilitate a manual review of a payment by utilizing visual inspection logic 190.

Visual inspection logic 190 represents any suitable set of instructions, logic, or code embodied in a computer-readable storage medium and operable to facilitate visual inspection of an image or other data associated with a payment. Visual inspection logic 190 may also utilize images, text, or other assets to facilitate visual inspection via a graphical user interface (“GUI”) 200 presented to a user. For example, upon determining an exception associated with a payment and executing perfection procedures 170, perfection module 100 may execute visual inspection logic 190 to present a GUI 200 that allows a user to manually evaluate the exception and provide input. In another example, perfection module 100 may communicate with a workstation 30 so that workstation 30 may present the GUI 200 and communicate the user input back to perfection module 100. Visual inspection related to different types of exceptions or payments may utilize the same visual inspection logic 190, portions of the same visual inspection logic 190, or entirely separate visual inspection logics 190.

In an exemplary embodiment of operation, a user submits a payment via endpoint 20. Endpoint 20 generates an image file related to the payment, such as, for example, an image of a check. Endpoint 20 then communicates the image file and, optionally, other information associated with the payment, to perfection module 100.

Upon receiving an image file, perfection module 100 determines data associated with the image file. Perfection module 100 may determine the data associated with the image file by analyzing the image file itself, or it may receive the data from another input source. For example, in one embodiment, perfection module 100 may utilize image analysis software to analyze the image file and extract data. In another embodiment, perfection module 100 may simply receive the data from endpoint 20 along with the image file. Perfection module 100 then executes perfection logic 140 to determine exceptions associated with the data by evaluating whether the data meets one or more exceptions rules 150. If the data does meet an exception rule 150, perfection module 100 then executes an appropriate perfection procedure 170. In some embodiments, perfection procedure 170 may utilize visual inspection logic 190, which facilitates the presentation of a GUI 200 to a user of a workstation 30. The user of workstation 30 then provides input accepting or modifying the data, or the user may flag the data for further exception handling. In additional embodiments, perfection module 100 communicates the perfected data to a posting application for further processing.

The automatic determination of one or more exceptions and subsequent data perfection may allow for faster processing of transactions. For example, in some embodiments, perfection module 100 may communicate the perfected data to a posting application within twenty-four hours of receiving the image file, though this time period is not required. In another embodiment, perfection module 100 may communicate the perfected data to a posting application within eighteen hours of receiving the image file. In yet another embodiment, perfection module 100 may communicate the perfected data to a posting application within twelve hours of receiving the image file.

Perfection module 100 may also generate alarms or alerts when one or more exceptions are detected or when other conditions arise that may require review or corrective action. For example, alarms or alerts may be generated to indicate that an exception associated with a payment has been detected, that a service-level agreement (“SLA”) has been compromised, or that data communicated to a posting application was not processed as expected. Alarms or alerts may also be generated to facilitate processing, logging, display, and/or review of statistics, metrics, or performance of perfection module 100 or another component of system 5. For example, alerts may be generated to provide real-time information regarding the number of payments, or particular types of payments, received by perfection module 100; the number of exceptions, or particular types of exceptions, detected by perfection module 100; the number of exceptions resolved or unresolved; the number of payments or exceptions associated with a particular endpoint 20 or type of endpoint 20; the number payments communicated to the posting application; or the dollar amount associated with any such events. Alerts may also provide real-time information regarding the rates of any such events or the number of such events that occur during a particular period of time. Alarms or alerts may also be generated in response to actions taken by users of workstations 30. For example, alerts can be generated when a user of workstation 30 suppresses or releases a scheduled task, or when a user of workstation 30 manually triggers a unscheduled task. Such alarms and alerts may facilitate more complete and/or more rapid evaluation of the performance and health of system 5 or a component of system 5. Such alarms and alerts may also provide an efficient mechanism for initiating corrective action in response to an alarm, alert, or other condition of system 5.

A component of system 5 may include an interface, logic, memory, and/or other suitable element. An interface receives input, sends output, processes the input and/or output, and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, system 5 may implement perfection procedures different from or in addition to those describe herein. As another example, multiple perfection modules 100 may operate in parallel to facilitate payment perfection. As yet another example, exception rules 150 may be configurable by a user of perfection module 100 or workstation 30, facilitating the modification of existing rules, deletion of existing rules, or insertion of additional rules. System 5 may include any number of endpoints 20, networks 10, perfection modules 100, and workstations 30. Any suitable logic may perform the functions of system 5 and the components within system 5.

FIG. 2 illustrates a particular embodiment of perfection logic 140, which facilitates the perfection of data for subsequent processing. Perfection logic 140 includes exception rules 150, perfection procedures 170, and visual inspection logic 190.

Exception rules 150 represent any suitable information operable to facilitate the determination of exceptions associated with a payment. Exception rules 150 also represent any suitable set of instructions, logic, or code embodied in a computer-readable storage medium and operable to facilitate the determination of exceptions associated with a payment. In the illustrated embodiment, exception rules 150 include high dollar rules 152, account correction rules 154, and duplicate detection rules 156.

High dollar rules 152 represent any suitable information operable to facilitate the determination of whether the amount of a payment exceeds a high dollar threshold. High dollar rules 152 also represent any suitable set of instructions, logic, or code embodied in a computer-readable storage medium and operable to facilitate the determination of whether the amount of a payment exceeds a high dollar threshold. For example, high dollar rules 152 may be configured to identify a high dollar amount exception when a payment exceeds a particular value. The value may be a fixed number, a percentage of another value, or another value determined by a formula. In some embodiments, different high dollar thresholds may be configured for different types of users, payment types, dates, accounts, or any other factor. When perfection module 100 determines that a payment meets a high dollar rule 152, high dollar review procedures are triggered. The triggered procedures may be performed immediately or at some point in the future.

Account correction rules 154 represent any suitable information operable to facilitate the determination of whether the data related to an account associated with the payment should be reviewed, accepted, modified, rejected, or further processed. Account correction rules 154 also represent any suitable set of instructions, logic, or code embodied in a computer-readable storage medium and operable to facilitate the determination of whether the data related to an account associated with the payment should be reviewed, accepted, modified, rejected, or further processed. For example, account correction rules 154 may be configured to facilitate the detection of incorrectly entered account information, legacy account numbers that require translation or reformatting, and/or other problems with account information that may require correction before the payment can post. In a particular embodiment, account correction rules 154 embody, reference, or incorporate a master account table, which may be part of account information 120 in memory 110. For example, account correction rules 154 may indicate that an account number associated with a payment does not match an entry in the master account table, which may indicate that the account number was written or otherwise entered incorrectly, that payment data refers to an outdated account number that requires correction or reformatting, or that a payment is fraudulent. When perfection module 100 determines that a payment meets an account correction rule 154, account correction procedures are triggered. The triggered procedures may be performed immediately or at some point in the future.

Duplicate detection rules 156 represent any suitable information operable to facilitate the determination of whether the a payment should be reviewed to identify a potential duplicate payment. Duplicate detection rules 156 also represent any suitable set of instructions, logic, or code embodied in a computer-readable storage medium and operable to facilitate the determination of whether a payment should be reviewed to identify a potential duplicate payment. For example, duplicate detection rules 156 indicate that certain factors such as identical payment amounts, check numbers, payments times, payment dates, payment issuers, payment recipients, and/or other factors indicate a potential duplicate payment. Duplicate detection rules 156 may also utilize a master index repository of past transactions that can be compared to subsequent payments. These factors and rules may be configured by a user of workstation 30 and may involve fixed rules and/or formulas. In an example embodiment, perfection module 100 may determine that a payment meets duplicate detection rules 156 because the payment amount matches a payment amount found in the master index repository of past transactions. When perfection module 100 determines that a payment meets a duplicate detection rule 156, duplication detection procedures are triggered. The triggered procedures may be performed immediately or at some point in the future.

Perfection procedures 170 represent any suitable set of instructions, logic, or code embodied in a computer-readable storage medium and operable to facilitate the perfection of payment data. In the illustrated embodiment, perfection procedures 170 include high dollar review procedures 172, account correction procedures 174, duplicate detection procedures 176, and extraction procedures 178.

High dollar review procedures 172 represent any suitable set of instructions, logic, or code embodied in a computer-readable storage medium and operable to facilitate review of payments flagged as high dollar payments to verify their correctness and/or authenticity. For example, when an evaluation of high dollar review rules 152 identifies a high dollar check, high dollar review procedures 172 may utilize visual inspection logic 190 to present a GUI 200 to a user of workstation 30. The user may view an image of the check and other information associated with the check, such as account information 120, transaction history, and/or other information. The user may then provide input indicating acceptance of the data, modification of the data, or flagging for further review, which may be performed immediately or at some point in the future.

Account correction procedures 174 represent any suitable set of instructions, logic, or code embodied in a computer-readable storage medium and operable to facilitate review of payments identified as potentially requiring account correction. For example, in one embodiment, when triggered by account correction rules 154, account correction procedures 174 may utilize visual inspection logic 190 to present a GUI 200 to a user of workstation 30. The user may view an image of the check and other information associated with the check, such as account information 120, and then provide input indicating acceptance of the data, modification of the data, or flagging for further review, which may be performed immediately or at some point in the future. In another embodiment, account correction procedures 174 may analyze and automatically update or reformat the data.

Duplicate detection procedures 176 represent any suitable set of instructions, logic, or code embodied in a computer-readable storage medium and operable to facilitate review of payments identified as potential duplicate payments. For example, if duplicate detection rules 156 indicate a potential duplicate payment, duplicate detection procedures 176 may utilize visual inspection logic 190 to present a GUI 200 to a user of workstation 30. The user may view an image of the check and other information associated with the check, such as account information 120, and then provide input indicating acceptance of the data, modification of the data, removal of a duplicate payment, or flagging for further review, which may be performed immediately or at some point in the future.

Extraction procedures 178 represent any suitable set of instructions, logic, or code embodied in a computer-readable storage medium and operable to facilitate the communication of a subset of payments to a posting application. For example, in one embodiment, after perfection module 100 has perfected the data associated with the payments involved in a transaction, extraction procedures 178 may communicate the payments to the posting application. In another embodiment, after perfection module 100 has perfected the data associated with the payments involved in a plurality of transactions, extraction procedures 178 may communicate the payments to the posting application. Extractions procedures 178 may be executed multiple times during a single day, executed at fixed or configurable intervals, executed after perfection of a fixed or configurable number of payments or transactions, and/or executed after perfection of individual payments or transactions. Thus, extraction procedures may allow posting of payments in a shorter amount of time, allowing payers and payees to view and/or utilize payments more quickly.

Visual inspection logic 190 represents any suitable set of instructions, logic, or code embodied in a computer-readable storage medium and operable to facilitate visual inspection of an image or other data associated with a payment. Visual inspection logic 190 may also utilize images, text, or other assets to facilitate visual inspection via a GUI 200 presented to a user. For example, upon determining an exception associated with a payment and executing perfection procedures 170, perfection module 100 may execute visual inspection logic 190 to present a GUI 200 that allows a user to manually evaluate the exception and provide input. In another example, perfection module 100 may communicate with a workstation 30 so that workstation 30 may present the GUI 200 and communicate the user input back to perfection module 100. Visual inspection related to different types of exceptions or payments may utilize the same visual inspection logic 190, portions of the same visual inspection logic 190, or entirely separate visual inspection logics 190. The GUI 200 may be generated by instructions sent to it by perfection module 100, by instructions already present on workstation 30, by instructions obtained from another source through network 10, or any combination thereof.

Perfection procedures 170 may also facilitate the generation, logging, display, and/or review of alarms and alerts, as described above. For example, upon detecting a particular exception, perfection procedures 170 may generate an alarm or alert to notify an administrator of the exception. Perfection procedures 170 may also generate alarms or alerts to facilitate the tracking of various system metrics. Such metrics may provide information regarding payments, exceptions, actions taken by users of workstations 30, extractions, or other events occurring within system 5. These alarms and alerts may facilitate the prompt notification of administrators or other users when certain conditions arise, and they may also facilitate the calculation and review of system metrics and system health.

Modifications, additions, or omissions may be made to perfection logic 140 without departing from the scope of the invention. For example, exceptions rules 150 may include some, all, or none of the rules shown in FIG. 2; and perfection procedures 170 may include some, all, or none of the procedures shown in FIG. 2. Exceptions rules 150 may also include additional rules, and perfection procedures 170 may include additional procedures as well. Perfection logic 140 may include any number of exception rules 150, perfection procedures 170, and visual inspection logics 190. Any suitable logic may perform the functions of perfection logic 140 and the components within perfection logic 140.

Furthermore, various components described above may be configured and/or managed before, during, and after processing. For example, a management interface may allow a user to pause the ingestion of files received from endpoints 20, bypass one or more exception rules 150 and/or exception procedures 170, run manual extraction of one or more payments in order to collect the one or more payments and present them downstream for posting.

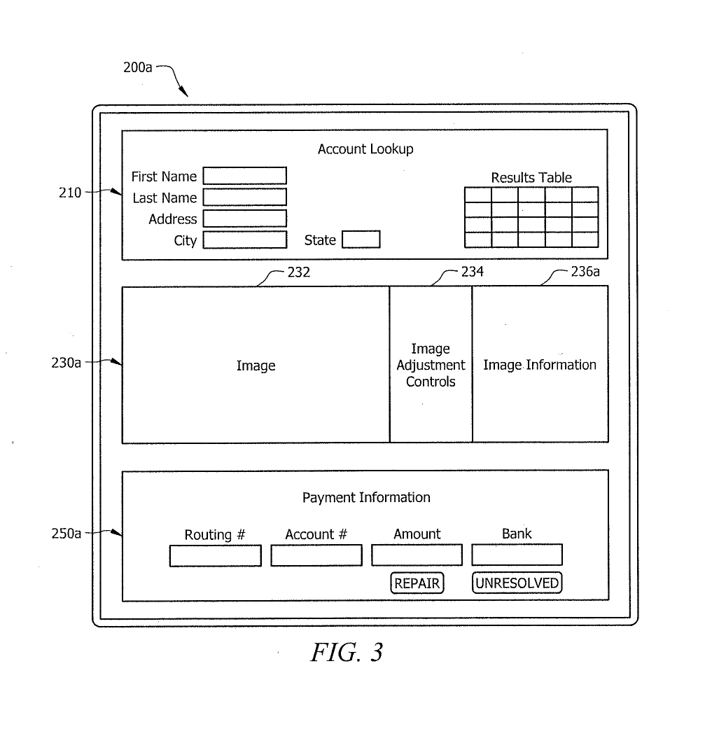

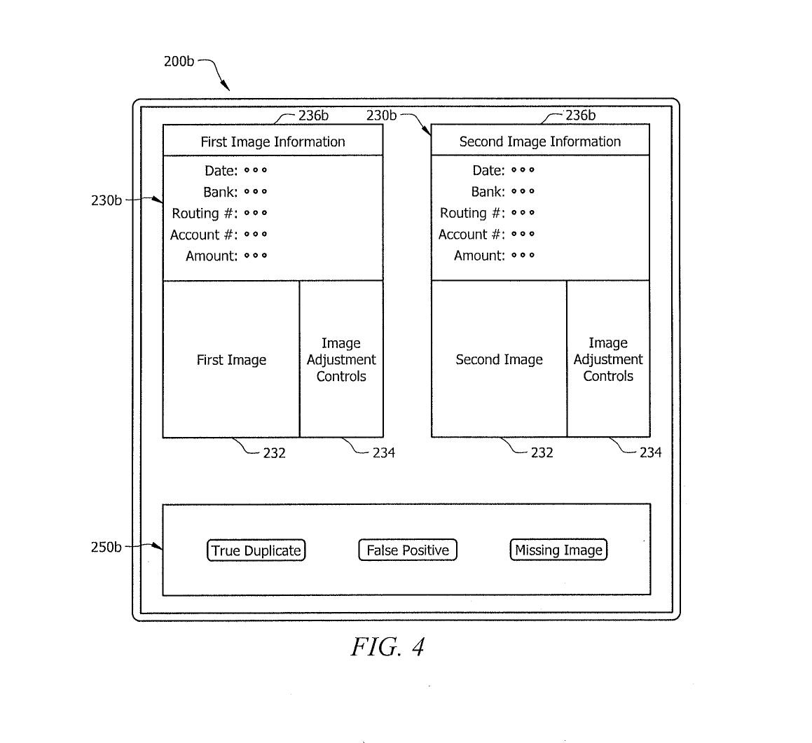

FIGS. 3 and 4 illustrate example GUIs 200, which facilitate review and input by a user regarding payment perfection. GUIs 200 may be presented on a display of one or more workstations 30 following execution of visual inspection logic 190. GUIs 200 are generally operable to tailor and filter data entered by and presented to the user. GUIs 200 may provide the user with an efficient and user-friendly presentation of information and may comprise a plurality of displays having interactive fields, pull-down lists, and buttons operated by the user. Different embodiments of GUI 200 may utilize common components, information, or computer code. GUIs 200 may include multiple levels of abstraction including groupings and boundaries. It should be understood that the term GUI may be used in the singular or in the plural to describe one or more GUIs 200 and each of the displays of a particular GUI 200.

FIG. 3 illustrates an example GUI 200a that facilitates review and input by a user related to account correction procedures 174. For example, if perfection module 100 evaluates account correction rules 154 and identifies an exception, it executes account correction procedures 174, which may utilize visual inspection logic 190 to facilitate the presentation of GUI 200a on a workstation 30. GUI 200a includes account lookup area 210, image area 230a, and user input area 250a.

Image area 230a facilitates review of an image associated with a payment, such as a photograph of a check communicated to perfection module 100 from a smart phone mobile application. Image area 230a presents a visual depiction of the image 232, image adjustment controls 234, which facilitate user manipulation of the image, and image information area 236a, which presents information associated with the image. For example, image 232 may depict a check submitted by a customer, and image information 236a may present information such as an account number, name, dollar amount, or other information associated with the check. This information may have been entered by the customer, entered by another user, or automatically determined by image analysis software.

Account lookup area 210 facilitates the lookup of account information related to a payment. A user of workstation 30 may review information area 230a and then enter information into account lookup area 210 to determine the accuracy of image information 236a. For example, a user may enter a name and address visible in image 232 into account lookup area 210, which may then lookup account information. In some embodiments, this lookup may utilize account information 120 or another centralized database of account information.

User input area 250a facilitates input by a user of workstation 30 in order to resolve an exception identified by perfection module 100. For example, in some cases, upon reviewing image area 230a and retrieving account information via account lookup area 210, the user of workstation 30 may identify a discrepancy in the account information and input the correct information into user input area 250a. The user may then interact with a button, such as the “repair” button shown in FIG. 3, or otherwise interact with workstation 30 in order to submit the corrected information, allowing for further processing of the payment. In other cases, the user of workstation 30 may be unable to resolve the exception identified by perfection module 100 and may interact with a button, such as the “unresolved” button shown in FIG. 3, or otherwise interact with workstation 30 in order to indicate that further exception handling is required. In some embodiments, this indication may trigger the execution of additional exception handling procedures that interact with a general ledger (not shown) that provides the ability to remove an item exception from a posting work steam without rendering a transaction out of balance. Indication that an exception is unresolved may also trigger the execution of exception bypass procedures (not shown) that replace the exceptions identified by perfection module 100 with work in process suspense entries. In some embodiments, indication that an exception is unresolved may also trigger interaction with an adjustment platform that serves as a repository for exceptions that will be addressed outside of the workflow of perfection module 100. In certain embodiments, the exceptions addressed outside of the workflow of perfection module 100 may be resolved during a longer time period that exceptions addressed within the workflow of perfection module 100. For example, while, in some embodiments, the payment perfection processing of perfection module 100 may be completed in one day or less, exceptions handled by the adjustment platform may be resolved in one to two days depending on the nature of the exception.

FIG. 4 illustrates another example GUI 200b that facilitates review and input by a user related to the detection of duplicate payments. For example, if perfection module 100 evaluates duplicate detection rules 156 and identifies an exception, it executes duplicate detection procedures 176, which may utilize visual inspection logic 190 to facilitate the presentation of GUI 200b on a workstation 30. GUI 200b includes two image areas 230b and user input area 250b.

Image areas 230b facilitate visual review of images associated with payment that are identified as potential duplicates. Image area 230b presents a visual depiction of the image 232, image adjustment controls 234, which facilitate user manipulation of the image, and image information area 236b, which presents information associated with the image. Image 232 is a visual depiction of a payment document, such as a scanned image of a check or other payment document communicated to perfection module 100 from a bank. Image information 236b may present information such as an account number, name, dollar amount, or other information associated with the check or other payment document. This information may have been entered by the customer, entered by a bank employee, or automatically determined by image analysis software. Image areas 230b may be presented on the same screen, as shown in FIG. 4, or on separate screens. The presentation of both images may allow a user of workstation 30 to visually inspect the potential duplicate payments to determine if they are in fact duplicates, or if the exception determined by perfection module 100 was a false positive.

User input area 250b facilitates input by a user of workstation 30 in order to resolve an exception identified by perfection module 100. For example, in some cases, upon reviewing image areas 230b and determining that the payments are in fact duplicates, the user of workstation 30 may interact with a button, such as the “true duplicate” button shown in FIG. 4, or otherwise interact with workstation 30 in order to indicate that the payments are duplicates. In other cases, the user of workstation 30 may determine that the payments are not duplicates and may interact with a button, such as the “false positive” button shown in FIG. 4, or otherwise interact with workstation 30 in order to indicate that the payments are not duplicates. In still other cases, the user may determine that an image file is missing and interact with a button, such as the “missing image” button shown in FIG. 4, or otherwise interact with workstation 30 to indicate that an image associated with one or more payments is missing. In some embodiments, this indication that an image is missing may trigger the execution of additional exception handling procedures that interact with a general ledger (not shown) that provide the ability to systematically remove an item exception from a posting work steam without rendering a transaction out of balance. Indication that an image is missing or that the exception is otherwise unresolved may also trigger the execution of exception bypass procedures (not shown) that replace the exceptions identified by perfection module 100 with work in process suspense entries. In some embodiments, indication that an exception is unresolved may also trigger interaction with an adjustment platform that serves as a repository for exceptions that will be addressed outside of the workflow of perfection module 100. In certain embodiments, the exceptions addressed outside of the workflow of perfection module 100 may be resolved during a longer time period that exceptions addressed within the workflow of perfection module 100. For example, while, in some embodiments, the payment perfection processing of perfection module 100 may be completed in one day or less, exceptions handled by the adjustment platform may be resolved in one to two days depending on the nature of the exception.

Similar GUIs 200 may also be used to facilitate user input related to other exceptions, such as those identified by high dollar rules 152 or other exception rules 150. Furthermore, various GUIs may have some, all, or none of the components shown in FIGS. 3 and 4. Various GUIs may also have additional components. For example, a GUI 200 may be used to facilitate duplicate detection of two or more payments simultaneously by presenting a series of image areas 230b, or by presenting controls to facilitate the cycling through of multiple images. As another example, some embodiments of GUI 200 may have different numbers and types of buttons in user input area 250, may present different pieces of information in image information area 236, and may have different layouts of the various components.

Additional GUIs may facilitate notification, review, and handling of alarms, alerts, or other system conditions. For example, GUIs may present various alarms or alerts generated by perfection module 100 during the processing of one or more payments. GUIs may also present information regarding various metrics of perfection module 100, such as the number of images received from a particular endpoint 20 or type of endpoint 20 during one or more time periods, the number or rate of exceptions detected by perfection module 100 during one or more time periods, the number or rate of payments communicated to a posting application, or one or more dollar amounts associated with such data. Such GUIs may facilitate more complete and/or more rapid evaluation of the performance and health of perfection module 100. Such GUIs may also provide an efficient mechanism for initiating corrective action in response to an alarm, alert, or other condition of perfection module 100.

The automatic detection of exceptions by perfection module 100 and subsequent presentation of GUIs 200 to facilitate user review of the images and/or exceptions may provide a more uniform, extensible, efficient, and streamlined method of payment perfection. For example, GUIs 200 may provide a single set of interfaces for facilitating review of multiple types of payments from multiple sources. This uniform set of interfaces may provide for more cost-effective development and debugging since updates to these components can be implemented in a single code base. Furthermore, the streamlined workflow of perfection module 100 may allow for more rapid posting of payments, since the payments may flow through the system unimpeded if no exceptions are automatically identified, and the exceptions that are identified by evaluation of exceptions rules 150 may be automatically presented for visual inspection using a common user-interface that facilitates swift review, correction if needed, and return of the payment to perfection module 100 for subsequent processing.

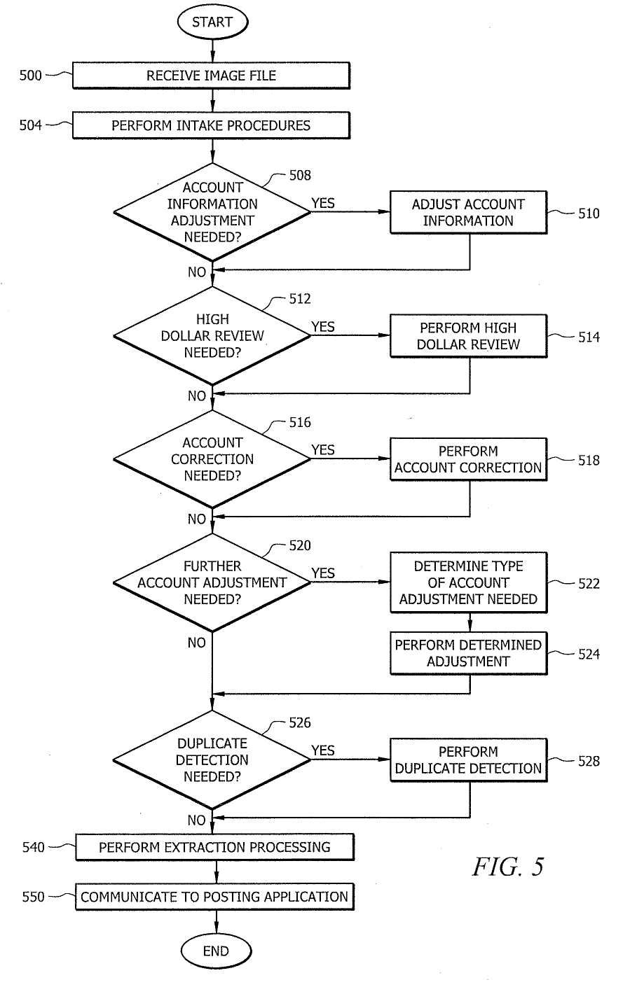

FIG. 5 is a diagram that illustrates a payment perfection sequence of perfection module 100.

At step 500, perfection module 100 receives an image file from an endpoint 20. The image file represents an image of a document associated with a payment, such as, for example, a picture or scan of a check or cash letter. In some embodiments, perfection module 100 may also receive data along with the image file. For example, a customer may submit a check at an ATM while also entering a payment amount. The ATM, or a bank associated with the ATM, may communicate an image of the check to perfection module 100 along with the entered payment amount and other information associated with the transaction, such as an account number. In some embodiments, endpoint 20 may also perform image analysis procedures, which may include review of the image by a user or automatic review of the document by image analysis software, in order to determine data associated with the payment.

At step 504, perfection module 100 performs intake procedures. Such procedures may include pre-processing of the image file and/or associated data to determine routes for processing based on file type. Intake procedures may also involve application of payment perfection rules to facilitate downstream processing and posting to the correct account. Perfection module 100 may also utilize image analysis processing to determine data associated with the image. For example, image analysis software could be used to analyze the image of a check to read an account number, payment amount, payer information, payee information, date, or other information associated with the payment. In other embodiments, perfection module 100 may determine data associated with the transaction simply by receiving data that has been generated elsewhere. For example, such data may have been entered manually by a customer or other user via endpoint 20, or endpoint may have performed its own image analysis processing to determine the data.

At step 508, perfection module 100 determines whether adjustment of account information is needed. For example, the image file may be associated with account information that is in an undesirable format. This may occur as a result of mergers and acquisitions whereby accounts associated with the formerly separate entity contain differently formatted account information. If perfection module 100 determines that adjustment is not needed, perfection module 100 proceeds to step 512. If perfection module 100 determines that adjustment is needed, perfection module 100 proceeds to step 510, where it adjusts account information.

At step 510, perfection module 100 may utilize a master table containing account information in order to reformat the legacy account records into the desired format. Upon adjusting account information, perfection module 100 proceeds to step 512.

At step 512, perfection module 100 determines if high dollar review is needed. Perfection module 100 evaluates high dollar rules 152 to determine if there is a high dollar exception associated with the payment. For example, in some embodiments, high dollar rules 152 may indicate that payments over a certain amount are to be flagged as high dollar exceptions and visually inspected. If no high dollar exception is determined, perfection module 100 proceeds to step 516. If a high dollar exception is determined, perfection module 100 proceeds to step 514, in which high dollar review is performed.

At step 514, perfection module 100 executes high dollar review procedures 172, which may utilize visual inspection logic 190. For example, perfection module 100 may communicate the image file and data associated with the image file to one or more workstations 30, which may present a GUI 200 similar to those shown in FIGS. 3 and 4. A user of workstation 30 may then visually inspect the image and associated data and determine whether to accept the data, modify of the data, or flag the payment for further exception handling. Once the data has been accepted or modified, perfection module 100 proceeds to step 516.

At step 516, perfection module 100 determines if account correction is needed. Perfection module 100 evaluates account correction rules 154 to determine if there is an account correction exception associated with the payment. For example, in some embodiments, account correction rules 154 may compare data associated with the payment, such as an account number, to an account information 120. If the account number is not a valid account number, if other information associated with the payment does not match the account information 120 associated with the account number, or if other account discrepancies are identified, perfection module 100 identifies an account correction exception. If no account correction exception is determined, perfection module 100 proceeds to step 520. If an account correction exception is determined, perfection module 100 proceeds to step 518, in which account correction is performed.

At step 518, perfection module 100 executes account correction procedures 174, which may utilize visual inspection logic 190. For example, perfection module 100 may communicate the image file and data associated with the image file to one or more workstations 30, which may present a GUI 200a as shown in FIG. 3. A user of workstation 30 may then visually inspect the image and associated data, look up account information using account information area 210, and determine whether to accept the data, modify of the data, or flag the payment for further exception handling. Once the data has been accepted or modified, perfection module 100 proceeds to step 520.

At step 520, perfection module 100 determines if further account adjustment is needed. Perfection module 100 may evaluate account information manually entered during a previous step to validate the accuracy of the information. For example, the manually entered account information may be compared against information in account information 120. If perfection module 100 determines that account adjustment is needed by identifying discrepancies in the data, perfection module 100 may proceed to step 522. If no account adjustment is needed, perfection module proceeds to step 526.

At step 522, perfection module 100 determines the type of adjustment needed. After determining the type of adjustment needed, perfection module 100 proceeds to step 524, in which it performs the determined adjustment. For example, perfection module 100 may perform additional visual inspection procedures similar to those described in steps 514 and 518, it may execute additional review procedures resulting in correction of the data and presentation for posting downstream, or it may remove the payment from the workflow of perfection module 100 altogether (not shown). Once the determined adjustment has been performed, perfection module 100 proceeds to step 526.

In some embodiments, if the steps prior to step 520 did not result in the modification of data associated with the payment by a user of workstation 30, step 520 may be skipped, and perfection module 100 may proceed directly to step 526.

At step 526, perfection module 100 determines if duplicate detection is needed. Perfection module 100 evaluates duplicate detection rules 156 to determine if there is an duplicate detection exception associated with the payment. For example, in some embodiments, duplicate detection rules 156 may compare data associated with the payment, such as an account number and a payment amount, to a master index of payments to determine if the information associated with the payment appears to match, or closely resemble, a previously presented payment. Duplicate detection rules 156 may also incorporate false positive filtering rules that identify payments that have legitimately been presented a second time in order to prevent unnecessary determinations of duplicate detection exceptions. For example, false positive filtering rules may identify rebate checks that have been issued to multiple parties, the checks having the same amount and serial number. If the payment does appear to be a potential duplicate according to duplicate detection rules 156, a duplicate detection exception is identified. If no duplicate detection exception is determined, perfection module 100 proceeds to step 540. If a duplicate detection exception is determined, perfection module 100 proceeds to step 528, in which duplicate detection is performed.

At step 528, perfection module 100 executes duplicate detection procedures 176, which may utilize visual inspection logic 190. Duplicate detection procedures 176 may execute a single item review, in which a single potential duplicate is inspected, or a multi-item review, in which two or more potential duplicate payments are inspected. Perfection module 100 may communicate the image file and data associated with the image file to one or more workstations 30, which may present a GUI 200b as shown in FIG. 3. A user of workstation 30 may then visually inspect the image and associated data, compare the image and/or data to the image and associated data of a previous payment, and determine whether to accept the data, modify of the data, or flag the payment for further exception handling. Once the data has been accepted or modified, perfection module 100 proceeds to step 540.

At step 540, perfection module 100 may perform extraction processing to prepare a payment or set of payments for communication to a posting application for subsequent processing. In some embodiments, the extraction processing of step 540 may be performed for every payment, while in other embodiments, step 540 may be executed after a certain number of payments are received, at certain time intervals, or after all payments associated with a particular transaction have been processed. Step 540 may involve the execution of extraction procedures 178 by perfection module 100. Extraction procedures 178 may create batches of payments or operate on individual payments. Extraction procedures 178 may be executed multiple times during a single day, executed at the end of the day, executed at fixed or configurable intervals, executed after perfection of a fixed or configurable number of payments or transactions, and/or executed after perfection of individual payments or transactions. In some embodiments, perfection module 100 may also determine whether one or more extractions were successfully received and/or processed by the posting application, and one or more alarms or alerts may be generated in response to this determination. For example, if a payment is communicated to the posting application but does not successfully post, an alert may be generated so that further action can be taken. After performing extraction procedures, perfection module 100 proceeds to step 550, in which perfection module 100 communicates the payment (or payments) to a posting application. Thus, extraction procedures 178 may facilitate the posting of payments in a shorter amount of time, allowing payers and payees to view and/or utilize payments more quickly. For example, payments may post to an account within one day of receiving the payment. Posting payments more quickly may improve the customer experience, reduce unit costs and risks associated with an institution that is performing the payment perfection and processing.

Various embodiments may perform some, all, or none of the steps described above. For example, certain embodiments may omit steps 520, 522, and 524 under certain conditions, or they may omit these steps entirely. Furthermore, certain embodiments may perform these steps in different orders. For example, in one embodiment, step 512 may be performed after step 516, and in another embodiment, step 526 may be performed before step 512.

Certain embodiments of the invention may provide one or more technical advantages. A technical advantage of one embodiment may provide a more streamlined and efficient payment perfection system, which may reduce costs associated with payment perfection and facilitate the posting of payments within a shorter time period. Another technical advantage of an embodiment allows a payment perfection system to handle different sources and types of payments with a single processing channel. Thus, subsequent updates to and development of the payment perfection system may apply to all types of payments and endpoints utilizing the system, providing larger economies of scale and improving the extensibility of the system.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for correcting a payment, comprising:
a network interface operable to receive an image file associated with a payment;
a memory operable to store account information;
a processor communicatively coupled to the network interface and the memory and operable to:
determine data associated with the image file;
automatically determine one or more exceptions associated with the data by evaluating if the data meets one or more exception rules, wherein evaluating if the data meets one or more exception rules comprises evaluating whether the data matches an entry in a master index repository of past transactions;
when the data meets one or more exception rules, evaluate whether the data meets one or more false positive filter rules, and in response to determining that the one of more exceptions is not a false positive associated with the data:
perform one or more data correction procedures triggered by the one or more exceptions to obtain corrected data; and
the network interface further operable to send the corrected data to a posting application; and
the processor further operable to:
determine that the payment was not successfully posted by the posting application; and
generate one or more alerts in response to the determination that the payment was not successfully posted by the posting application.

2. The system of claim 1, wherein the data comprises an account number and a transaction amount.

3. The system of claim 2, wherein evaluating if the data meets one or more exception rules comprises evaluating whether the transaction amount exceeds a high dollar exception trigger value and, if the transaction amount does exceed the high dollar exception trigger value, performing one or more high dollar review procedures.

4. The system of claim 2, wherein evaluating if the data meets one or more exception rules comprises evaluating whether the account number matches an entry in a master account table and, if the account number does not match an entry in the master account table, performing one or more account correction procedures.

5. The system of claim 1, wherein the one or more data correction procedures comprise:
retrieving the image file;
presenting an image based on the image file on a display screen; and
receiving input from a user indicating a selected one of acceptance of the data, modification of the data, and flagging for further exception handling.

6. The system of claim 1, wherein sending the corrected data to a posting application comprises performing a plurality of extraction procedures, each extraction procedure comprising communicating corrected data associated with a transaction to the posting application.

7. A method, comprising:
receiving an image file, the image file associated with a payment;
determining, by a processor, data associated with the image file;
automatically determining, by the processor, one or more exceptions associated with the data by evaluating if the data meets one or more exception rules, wherein evaluating if the data meets one or more exception rules comprises evaluating whether the data matches an entry in a master index repository of past transactions;
when the data meets one or more exception rules, evaluating, by the processor, whether the data meets one or more false positive filter rules, and in response to determining that the one of more exceptions is not a false positive associated with the data:
performing, by the processor, one or more data correction procedures triggered by the one or more exceptions to obtain corrected data; and
sending, by the processor, the corrected data to a posting application;
determining, by the processor, that the payment was not successfully posted by the posting application; and
generating, by the processor, one or more alerts in response to the determination that the payment was not successfully posted by the posting application.

8. The method of claim 7, wherein the data comprises an account number and a transaction amount.

9. The method of claim 8, wherein evaluating if the data meets one or more exception rules comprises evaluating whether the transaction amount exceeds a high dollar exception trigger value and, if the transaction amount does exceed the high dollar exception trigger value, performing one or more high dollar review procedures.

10. The method of claim 8, wherein evaluating if the data meets one or more exception rules comprises evaluating whether the account number matches an entry in a master account table and, if the account number does not match an entry in the master account table, performing one or more account correction procedures.

11. The method of claim 7, wherein the one or more data correction procedures comprise:
retrieving the image file;
presenting an image based on the image file on a display screen; and
receiving input from a user indicating a selected one of acceptance of the data, modification of the data, and flagging for further exception handling.

12. The method of claim 7, wherein sending the corrected data to a posting application comprises performing, a plurality of extraction procedures, each extraction procedure comprising communicating corrected data associated with a transaction to the posting application.

13. Logic embedded in a computer readable storage medium and operable, when executed by a processor, to:
receive an image file, the image file associated with a payment;
determine data associated with the image file;
automatically determine one or more exceptions associated with the data by evaluating if the data meets one or more exception rules, wherein evaluating if the data meets one or more exception rules comprises evaluating whether the data matches an entry in a master index repository of past transactions;
when the data meets one or more exception rules, evaluate whether the data meets one or more false positive filter rules, and in response to determining that the one of more exceptions is not a false positive associated with the data:
perform one or more data correction procedures triggered by the one or more exceptions to obtain corrected data; and
send the corrected data to a posting application;
determine that the payment was not successfully posted by the posting application; and
generate one or more alerts in response to the determination that the payment was not successfully posted by the posting application.

14. The logic of claim 13, wherein the data comprises an account number and a transaction amount.

15. The logic of claim 14, wherein evaluating if the data meets one or more exception rules comprises evaluating whether the transaction amount exceeds a high dollar exception trigger value and, if the transaction amount does exceed the high dollar exception trigger value, performing one or more high dollar review procedures.

16. The logic of claim 14, wherein evaluating if the data meets one or more exception rules comprises evaluating whether the account number matches an entry in a master account table and, if the account number does not match an entry in the master account table, performing one or more account correction procedures.

17. The logic of claim 13, wherein the one or more data correction procedures comprise:
retrieving the image file;
presenting an image based on the image file on a display screen; and
receiving input from a user indicating a selected one of acceptance of the data, modification of the data, and flagging for further exception handling.

18. The logic of claim 13, wherein sending the corrected data to a posting application comprises performing a plurality of extraction procedures, each extraction procedure comprising communicating corrected data associated with a transaction to the posting application.
